(19) United States
(12) Patent Application Publication
(10) Pub. No.: US 2008/0313831 A1
(43) Pub. Date: Dec. 25, 2008

(54) Powered Drain Cleaning Tool

(76) Inventors: James A. Kovach, Parma, OH (US); Charles J. Mintz, Highland Hts, OH (US)

Correspondence Address: JEANNE E. LONGMUIR, 2836 CORYDON ROAD, CLEVELAND HEIGHTS, OH, 44118, US

(21) Appl. No.: 12/118,716

(22) Filed: May 10, 2008

Related U.S. Application Data
(60) Provisional application No. 60/917,311, filed on May 10, 2007.

(51) Int. Cl. A46B 13/02; A47L 25/00; B08B 9/027

(52) U.S. Cl. 15/25; 15/88; 134/22.11

(57) ABSTRACT

A powered hand held drain cleaning tool and method of operation, including a stick tool member with a brush or teeth on a first end, a hex engagement portion on a second end and an elongate, non-uniform, shaft portion extending between the first and second ends. The tool includes a body portion for housing a power supply, a motor for rotating a drive mechanism engaged with the hex engagement portion of the stick tool member, and a trigger switch mechanism for operation of the tool by a user. The body is also engaged with a face piece with an opening for receiving the stick tool member therethrough, and pin members for mating and locking engagement with locking grooves formed in the body portion.

### CROSS-REFERENCE TO RELATED APPLICATIONS

The present application claims priority from U.S. patent application Ser. No. 60/917,311 filed May 10, 2007, the entire subject matter of which is incorporated herein by reference.

### BACKGROUND OF THE INVENTION

1. Field of Invention

The present invention is directed to a hand held powered drain cleaning tool.

2. Background of the Related Art

In the past, the removal of tub and sink drain clogs by home owners has been accomplished by a variety of methods. Depending on the clog, chemicals may be purchased and poured down the drain. Concerns regarding damage to plumbing pipes and water quality have resulted in a decrease in interest in the use of such chemicals by home owners. Snakes, or spring wire housed by winding the spring into and out of a casing, of the type used by professional plumbers, are also available for more difficult clogs. Such tools are often difficult to use, and generally result in removal of the dirty and smelly clogging materials out of the drain and into the tub or sink for disposal by the home owner.

A non-powered hand held Drain Stick® drain clearing probe is also available, as set forth in U.S. Design Patent No. D458,426. The consumer inserts and removes the probe or stick tool into and out of the drain, dislodging the clogging materials from the drain pipe for their removal down the drain. The stick tool has the advantage that the clogging materials are washed down the drain, and need not be removed from the drain for a messy disposal by the home owner. Expensive professional plumbers may also be called in the event the clog can not be removed using conventional techniques.

### BRIEF SUMMARY OF THE INVENTION

The present application provides an improved drain cleaning tool. The tool is a hand held battery powered tool which includes a rotating stick tool member inserted into the drain for engagement with and dislodging of the clogging materials. The tool includes a removable, replaceable stick tool member and a powered hand held assembly. The hand held assembly includes a body portion housing a power supply, a motor operating a drive mechanism for providing rotating movement of the stick tool member, and an on/off trigger operated switch for operating the motor. A locking face piece is also provided for removable, locking attachment to the body portion of the hand held assembly. The face piece may be opened for insertion of the stick tool member into the drive mechanism. Once the stick tool member is in position, the locking face piece is then moved to surround the stick tool member into engagement with the drive mechanism. Finally, the face piece is locked into engagement with the body portion of the hand held assembly, and the improved drain tool is ready for operation. Alternatively, a reversing or rocking switch may also be provided for reversing direction of the motor, thereby reversing the rotation direction of the stick member.

Additionally, the rotating stick tool member of the improved drain cleaning tool has a tapered shaft section or a non-uniform elongate shaft, and a hex shaped end portion for engagement with the drive mechanism of the hand held assembly. Still further the stick tool member may alternatively be manufactured of a variety of materials. Several of such materials are Nylon 6, Nylon 6:6 or impact modified Nylon. While not required, if it is desired to provide additional strength to the stick tool enabling insertion through the bent plumbing pipe to the trap, but at the same time resisting twisting, such that the tool does not coil or otherwise deform during operation, a nano-composite material may also be used which further stiffens the stick tool during rotation, but allows it to flex along its longitudinal axis during insertion into the drain. In general, such nano-composite materials are manufactured such that the composite material resides at the surface of the material. As a result, the stick tool behaves somewhat like tubing. It resists twisting or rotation about the longitudinal axis of the tool, but allows strength along the longitudinal axis and for inserting the stick tool into the clog, as well as flexibility for bending through the plumbing drain pipes.

### BRIEF DESCRIPTION OF DRAWINGS

FIG. 1 illustrates a perspective view of the powered hand held drain cleaning tool of the present application;

FIG. 2 illustrates an enlarged partial view of the brush end of a stick tool member of the powered hand held draining cleaning tool of FIG. 1;

FIG. 3 illustrates a left side view of the powered hand held assembly of the tool of FIG. 1;

FIG. 4 illustrates a right side view of the powered hand held assembly of the tool of FIG. 1;

FIG. 5 illustrates a front view of the powered hand held assembly of the tool of FIG. 1;

FIG. 6 illustrates a bottom view of the powered hand held assembly of the tool of FIG. 1;

FIG. 7 illustrates an end or back view of the powered hand held assembly of the tool of FIG. 1;

FIG. 8 illustrates a top view of the powered hand held assembly of the tool of FIG. 1;

FIG. 9 illustrates a partial, exploded view of the motor interconnection to the power supply within the powered hand held assembly of the tool of FIG. 1;

FIG. 10 illustrates a partial, exploded view of the trigger switch, including the electrical contacts which engage to activate rotation of the motor upon the application of pressure to the trigger by the tool user;

FIG. 11 illustrates a partial, exploded view of the powered hand held assembly of the tool of FIG. 1 with the cover of the assembly removed to illustrate the assembled components, such as a power supply interconnected with the motor and drive mechanism, including a gear housing covered by a front face piece, all contained within the hand held assembly;

FIG. 12 illustrates a further exploded, partial view of the disassembled components of the powered hand held assembly;

FIG. 13 illustrates a partial exploded view of the front face piece disconnected from the assembly, with the stick tool member about to be engaged with the drive mechanism;

FIGS. 15a-15c illustrate the steps for removing the stick tool member from the front face piece and assembly; and

FIGS. 16a-16c illustrate partial, cut away views of the stick tool member.

### DETAILED DESCRIPTION OF A PREFERRED EMBODIMENT

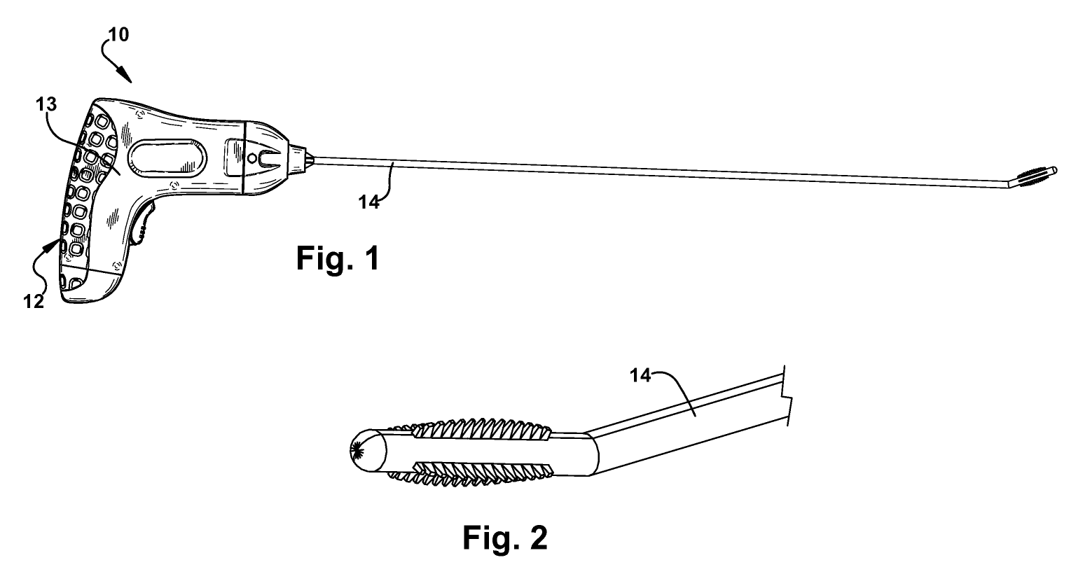

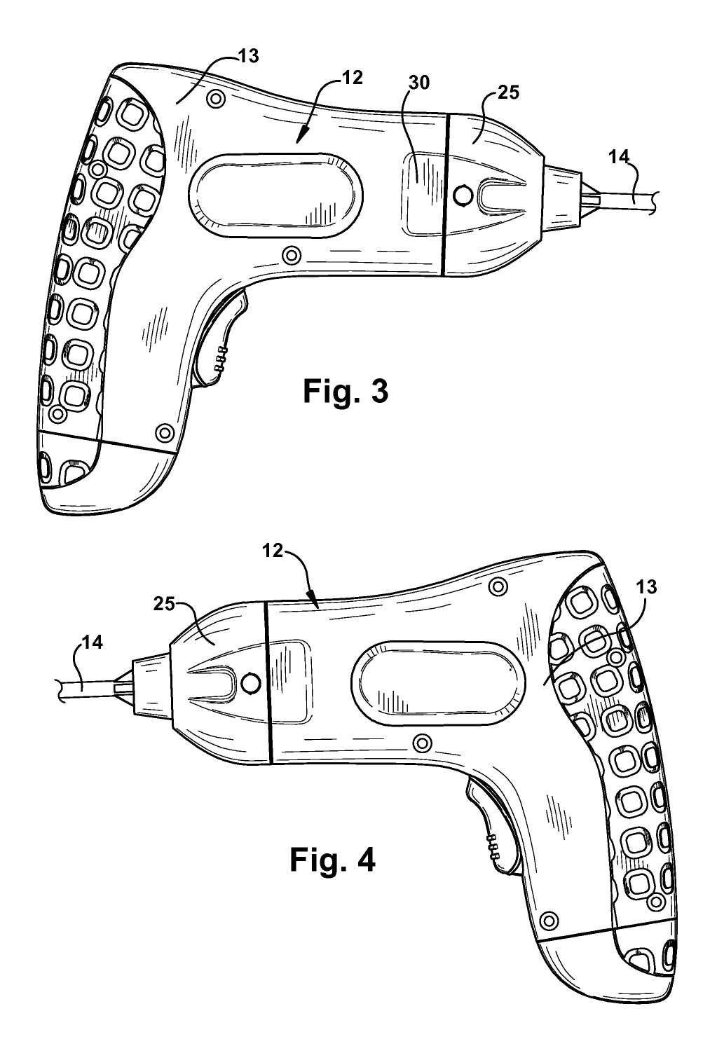

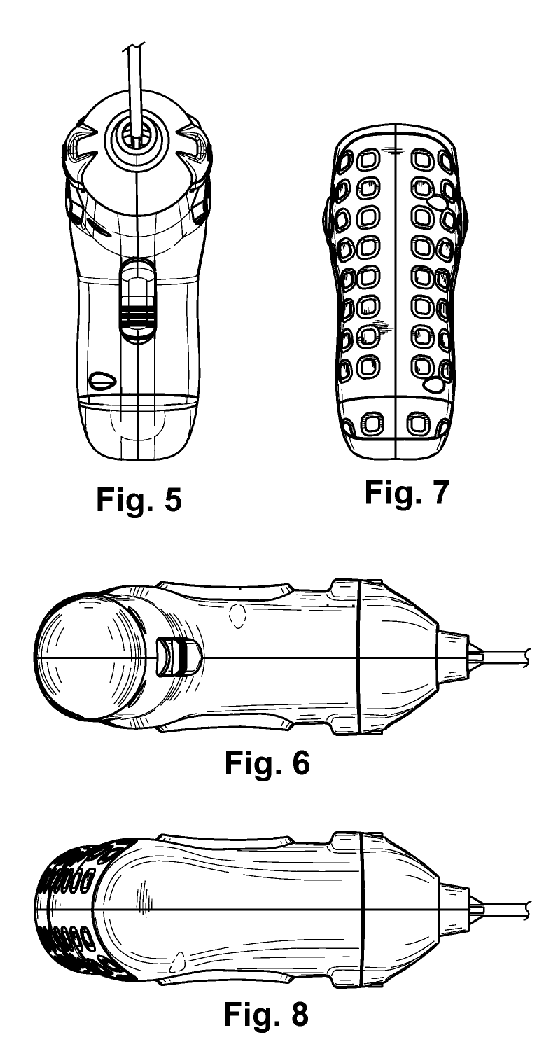

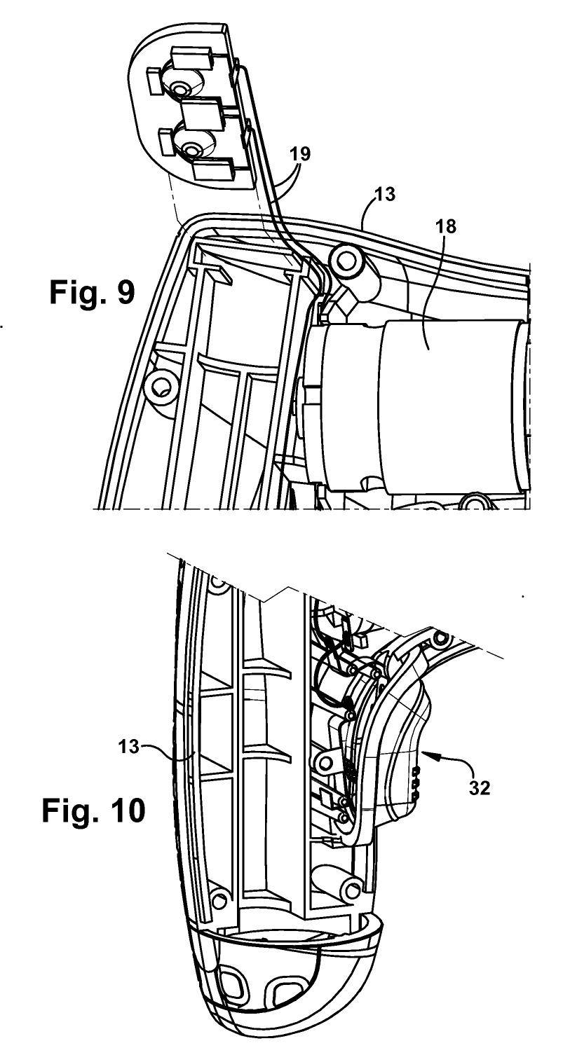

FIGS. 1 to 8 illustrate the external aspects of the powered hand held drain cleaning tool 10 of the present application. The device 10 includes a powered hand held assembly 12 and a removable, moving stick tool member 14. Various external, internal and exploded views of the hand held assembly 12, which engages the stick tool member 14 in the present improved powered drain cleaning tool, are shown in FIGS. 9-16.

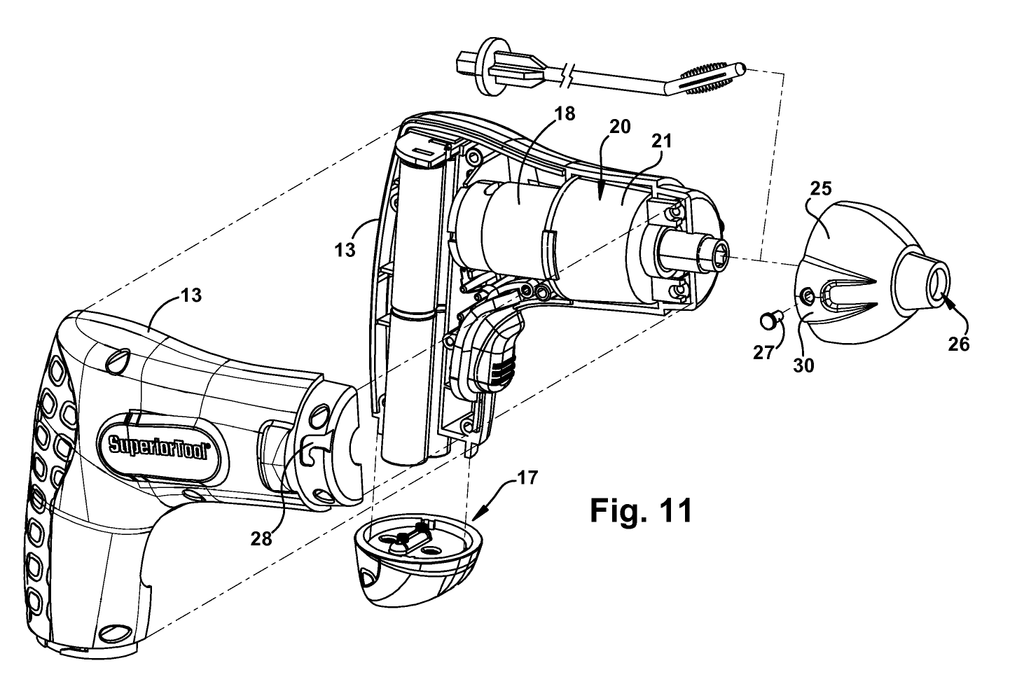

As shown in FIG. 11, the powered hand held assembly 12 has a body 13 having two halves, which together form several internal compartments. One such compartment is closed by a lid 17, and houses a power supply 16, shown here in the form of 2 AA alkaline batteries. The power supply 16 is electrically interconnected via the contacts and wires 19, with a motor 18, an interconnected drive mechanism 20 and a trigger switch 32, which are housed within the body 13. An enlarged view of the electrical interconnections with the motor 18 is shown in FIG. 9. An enlarged view of the trigger switch 32 extending from the body 13, is shown in FIG. 10. A finger trigger surface is provided over a conventional electrical polyswitch which turns off the motor within 10-12 seconds if the stick tool member fails to rotate or is under other overload or potentially damaging conditions. This avoids breakage of the stick tool member in the event it is unable to move due to engagement with the clogging material.

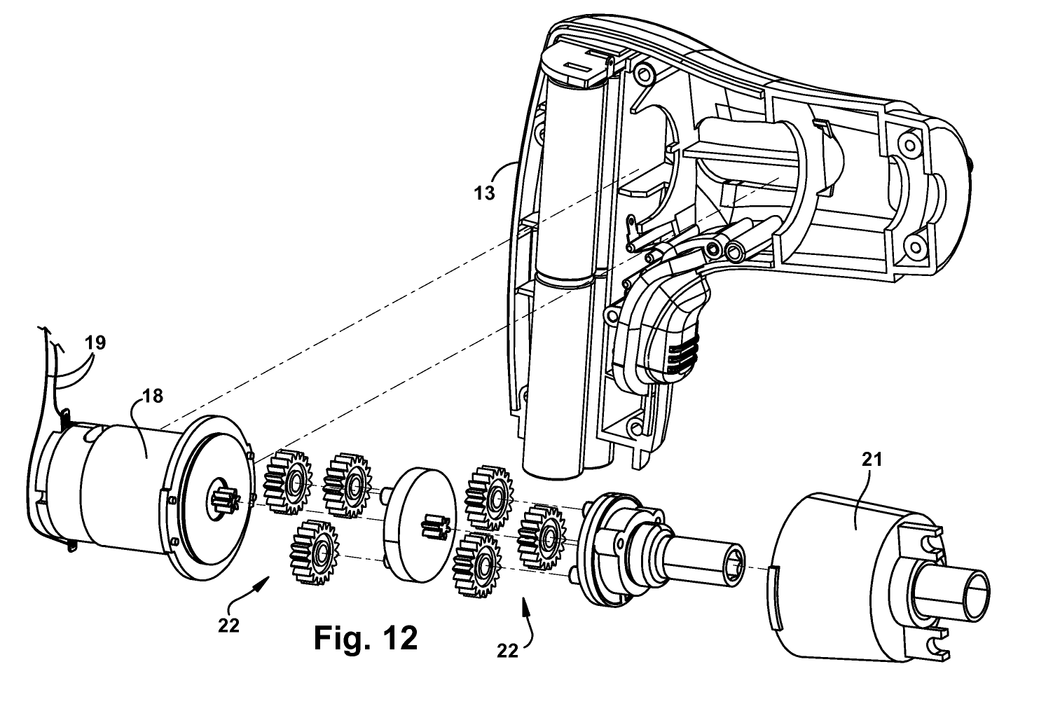

The drive mechanism 20 includes a gear housing 21 containing and the engaged gears 22, which enable the desired gear reduction during and for operation. The drive mechanism 20 is shown in the exploded view of FIG. 12, which also contains a sealing gasket 23 and a shaft 24 for rotating interconnection with the motor 18. The drive mechanism 20 is covered by a front face piece 25, which includes an opening 26, through which the stick tool member 14 is passed into operating engagement with the assembly 12.

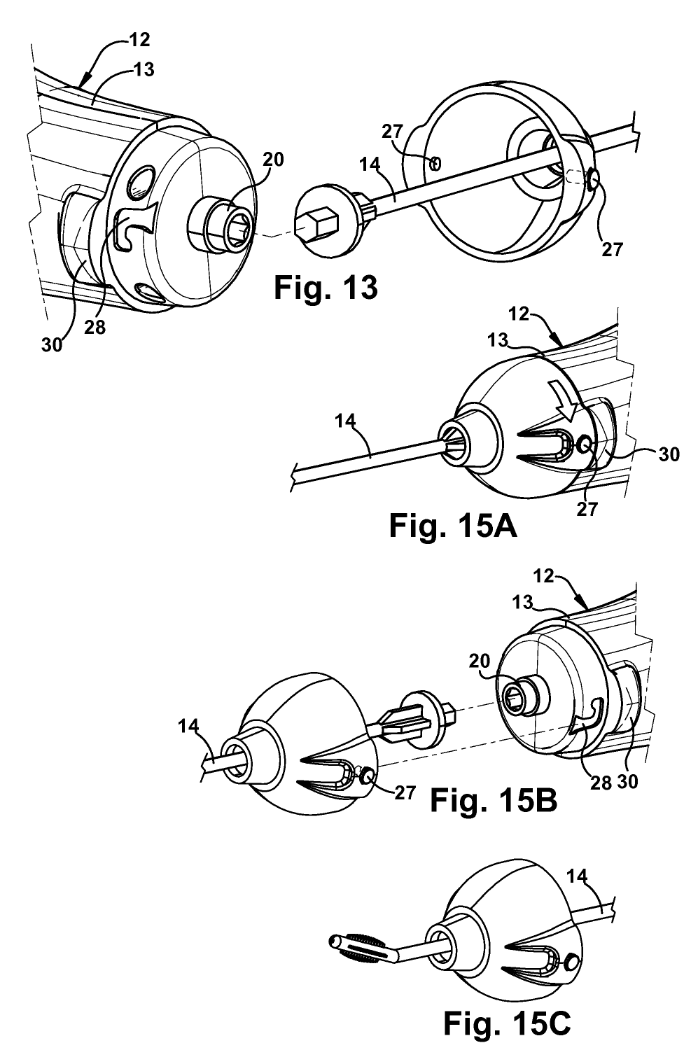

The figures provided illustrate that the front face piece 25 locks into engagement on the assembly 12 upon camming engagement of pin members 27 within locking grooves 28. As shown in FIG. 13, locking grooves 28 are formed within the body 13. The front face piece 25 is provided with at least 2 pin members 27 which extend from opposite sides of an internal portion of the front 25 face piece, as shown in FIGS. 11 to 13. To lock the front face piece 25 to the body 13, the pin members 27 are engaged within the locking grooves formed on each side of the hand held assembly, by pushing and turning until they are locked in position.

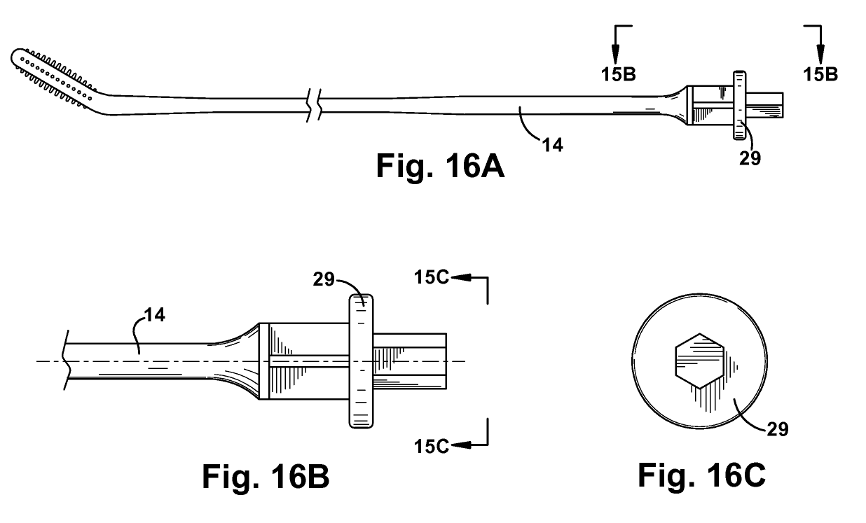

FIGS. 16a-16c illustrate the improved stick tool member 14 of the present application. The stick tool member 14 has teeth or a bristle brush first end portion, an elongate tapered shaft portion and a hex shaped second end portion for engagement with the powered hand held assembly 12. The elongate shaft portion extends between the first and second ends. As shown, the hex shaped second end portion engages a mating hex shaped opening in the drive mechanism 20, which extends from the powered hand held assembly, as shown in FIG. 13. To install the stick tool member 14, when the front face piece is removed from the body 13, the brush or toothed end of the stick tool member 14 and the shaft portion are threaded through the opening 26 in the front face piece 26. The hex shaped end of the stick tool member 14 is then engaged with a mating hex opening in the drive mechanism 20. Once the stick tool member 14 is in position, the front face piece 25 is locked down onto the body 13 by engagement of the pins 27 within the locking grooves 28 to surround and secure the stick tool member. Finally, the front face piece 25 is locked into engagement with the body 13 of the hand held assembly 12 by moving the pin members 27 extending from the front face piece fully into the grooves 28. Boss portions 30 are provided on the body 13 and adjacent the pins 27 for ease of finger operation by the user. A reverse operation for removal and cleaning of the stick tool member 14 is illustrated in FIGS. 15a to 15c.

It should be understood that the hex shaped end of the stick tool member 14 and the mating hex opening in the drive mechanism 20 are provided to resist slippage against the motor torque, however, additional alternate shapes which resist slippage may also be used. A flange 29 is also provided intermediate the hex shaped end and the shaft portion of the stick tool member. When locked in position, the flange 29 is positioned in front of the hex opening of the drive mechanism 20 to contact the inside of the front face piece 25 when cammed in locked position, and serves to resist removal during rotating operation of the stick tool member 14 by the drive mechanism 20.

To use the device 10, the toothed end of the stick tool member 14 is placed into the drain while pulling the trigger, so that the stick tool member is rotating while placing it into the drain. The stick tool member may be threaded through the drain stopper or cover. The stick tool member should be gently worked down the drain and allowed to run for 3-10 second intervals. The device 10 should not run for longer than one (1) minute at a time. To test is the drain has been cleared, water may be run into the drain. Continue the process until the drain clog is cleared. To clean the stick tool member, any disinfectant cleaner may be used to wash residue. If a clog is stuck on the end, remove the stick tool member from the powered hand held assembly and gently tease the clog off the teeth. Then wash with any disinfectant. Alternately, the clog may be removed by cutting off the end of the stick tool member, then removing the remaining stick tool member from the body, and replacing the damaged stick tool member.

As mentioned, the use of several materials is possible in the stick tool member component of the tool. For example, a nano-composite material in the improved drain cleaning tool may be used according to a mix of approximately 80% of Nylon 6:6 and approximately 20% of the nano-composite material. The nano-composite material is of the type disclosed in PCT/US2005/033945 entitled Impact-Modified Polyamide Compounds, the entire subject matter of which is incorporated herein by reference. Such nano-composite materials are available from Poly-One Corporation of Avon Lake, Ohio. Alternatively, conventional Nylon materials such as Nylon 6 or Nylon 6:6 material may also be used. Such materials are available from numerous sources, including Poly-One Corporation.

It should be understood that the improved stick tool member of the present application may be used either engaged with for rotation by the hand held assembly of the present application, or, alternatively, may be used by hand for insertion into a clogged drain.

While the present improved powered drain cleaning device and methods for its use have been described herein in connection with one or more embodiments, it is understood that it should not be limited in any way, shape or form to any specific embodiment but rather constructed in broad scope and breadth in accordance with the recitation of the following claims.

We claim:

1. A powered hand held drain cleaning tool comprising,
a stick tool member having a brush on a first end, a hex engagement portion on a second end and an elongate, non-uniform, shaft portion extending between the first and second ends;
a body portion for housing a power supply, a motor for rotating a drive mechanism engaged with the hex engagement portion of the stick tool member, and a trigger switch mechanism for operation of the tool by a user; and
a face piece having an opening for receiving the stick tool member there through, and pin members for mating and locking engagement with locking grooves formed in the body portion.

2. A drain cleaning stick tool having a first end forming a bristle brush and an elongate shaft member extending from the first end and having a non-uniform cross section.

3. The drain cleaning stick tool of claim 2 manufactured of approximately 80% by weight of Nylon 6:6 and approximately 20% by weight of a nano-composite polyamide material.

4. The drain cleaning stick tool of claim 2 manufactured of Nylon 6:6 material.

5. The drain cleaning stick tool of claim 2 manufactured of Nylon 6 material.

6. A powered hand held drain cleaning tool comprising,
a stick tool member having teeth on a first end, a hex engagement portion on a second end and an elongate, shaft portion extending between the first and second ends;
a body portion for housing a power supply, a motor for rotating a drive mechanism engaged with the hex engagement portion of the stick tool member for rotation of the stick tool member, and a switch mechanism for operation of the tool by a user; and
a face piece having an opening for receiving the stick tool member therethrough, and for locking engagement of the face piece with respect to the body portion.

6. The powered hand held drain cleaning tool of claim 6, wherein said teeth form a bristle brush and the elongate shaft portion extending from the first end has a non-uniform cross section.

7. The powered hand held drain cleaning tool of claim 7, wherein the stick tool member is manufactured of approximately 80% by weight of Nylon 6:6 and approximately 20% by weight of a nano-composite polyamide material.

8. The powered hand held drain cleaning tool of claim 7, wherein the stick tool member is manufactured of Nylon 6:6 material.

9. The powered hand held drain cleaning tool of claim 7, wherein the stick tool member is manufactured of Nylon 6 material.

11. A method for cleaning a drain comprising the steps of:
inserting a stick tool member having teeth on a first end, an elongate, non-uniform cross-sectioned shaft portion, and a hex engagement portion on a second end for locking engagement with a powered hand held assembly;
operating a powered hand held assembly to rotate the stick tool member while inserting the stick tool member into a clogged drain; and
maintaining rotation of the stick tool member for intervals of approximately of less than one minute, until the clog is cleared from the drain.
